(19) United States
(12) Patent Application Publication
(10) Pub. No.: US 2017/0034098 A1
(43) Pub. Date: Feb. 2, 2017

(54) COMMUNICATION APPARATUS AND RECEIVED DATA ANALYSIS METHOD

(71) Applicants: KABUSHIKI KAISHA TOSHIBA, Tokyo (JP); TOSHIBA TEC KABUSHIKI KAISHA, Tokyo (JP)

(72) Inventor: Satoshi Tokuda, Mishima (JP)

(21) Appl. No.: 14/809,639

(22) Filed: Jul. 27, 2015

(51) Int. Cl. H04L 12/58

(52) U.S. Cl. CPC H04L 51/22

(57) ABSTRACT

A communication apparatus in an embodiment includes a transmission data generation unit, a network interface, and a received data analysis unit. The transmission data generation unit generates transmission data by setting an e-mail address of another apparatus in a BCC item in an e-mail, and setting an e-mail address of the communication apparatus in a To item in the e-mail. The network interface transmits the generated transmission data to an apparatus which is set in the BCC item and the To item, and receives transmission data. The received data analysis unit analyzes the received transmission data, and when the transmission data is data which is transmitted from the communication apparatus, the transmission data is discarded and job registration is not performed, and when the transmission data is not data which is transmitted from the communication apparatus, job registration is performed.

### FIELD

Embodiments described herein relate generally to a communication apparatus and a received data analysis method.

### BACKGROUND

In the related art, an image forming apparatus such as a multi function peripheral (MFP) having an iFAX function is known. The iFAX function includes a function capable of setting the e-mail address of the destination (hereinafter, referred to as “destination address”) in a Blind Carbon Copy (BCC) item, and transmitting an e-mail. However, if the destination address is set only in the BCC item and an e-mail is transmitted, a server or a mailer may recognize the e-mail as junk e-mail. As a result, the e-mail may automatically be discarded. Thus, inputting one or more destination addresses to the To item of an e-mail is considered. For example, there is a method of transmitting an e-mail by using an iFAX function, by automatically setting the e-mail address of a source (hereinafter, referred to as “source address”) in the To item, and setting the destination address in the BCC item.

However, in the above method, since the source address is set in the To item, the transmitted e-mail is received in the MFP of the source. Thus, whenever the e-mail is transmitted by the iFAX function, there is a possibility of processing such as printing or transferring being performed in the MFP of the source of the e-mail.

As described above, there is a possibility of useless processes being performed in order to send an e-mail to the destination that is set in the BCC item. Such a problem is not limited to an image forming apparatus having an iFAX function, and occurs commonly in the entirety of communication apparatuses which can set the destination address only in the BCC item and send an e-mail.

### DESCRIPTION OF THE DRAWINGS

FIG. 1 is an external view illustrating an example of an image forming apparatus in a first embodiment.

FIG. 2 is a block diagram illustrating a functional configuration.

FIG. 3 is a schematic block diagram illustrating a functional configuration of a CPU.

FIG. 4 is a diagram illustrating a specific example of a setting screen.

FIG. 5 is a diagram illustrating a specific example of an input screen.

FIG. 6 is a flowchart illustrating a flow of a process at the time of iFAX transmission by the image forming apparatus.

FIG. 7 is a flowchart illustrating a flow of a process at the time of iFAX reception.

FIG. 8 is a schematic block diagram illustrating a functional configuration of a CPU in a second embodiment.

FIG. 9 is a diagram illustrating an example in which specific identification information is added to a header of transmission data.

FIG. 10 is a flowchart illustrating a flow of a process at the time of iFAX transmission.

FIG. 11 is a flowchart illustrating a flow of a process at the time of iFAX reception.

### DETAILED DESCRIPTION

A communication apparatus of an embodiment includes a transmission data generation unit, a network interface, and a received data analysis unit. The transmission data generation unit generates transmission data by setting an e-mail address of another apparatus in a BCC item in an e-mail, and setting an e-mail address of the communication apparatus in a To item in the e-mail. The network interface transmits the generated transmission data to an apparatus which is set in the BCC item and the To item, and receives transmission data. The received data analysis unit analyzes the received transmission data, when the transmission data is data which is transmitted from the communication apparatus, the transmission data is discarded and job registration is not performed, and when the transmission data is not data which is transmitted from the communication apparatus, job registration is performed.

Hereinafter, communication apparatuses and received data analysis methods of embodiments will be described with reference to the drawings. In addition, in the following description, an image forming apparatus having an iFAX function will be described as an example of the communication apparatus.

### First Embodiment

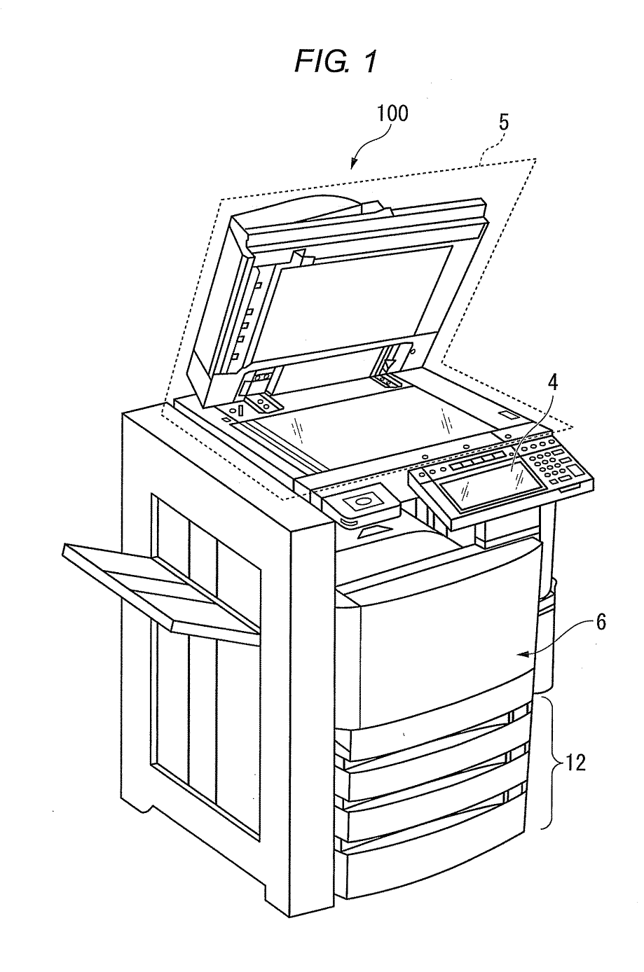

FIG. 1 is an external view illustrating an example of an image forming apparatus 100 in a first embodiment.

The image forming apparatus 100 reads an image on a sheet and generates digital data (an image file). For example, the image forming apparatus 100 is a multi function peripheral (MFP) capable of forming a toner image on the sheet. For example, the sheet is a recording medium such as an original document or paper on which characters and images are printed, or may be any object as long as the image forming apparatus 100 can read the images on the object. Further, the image forming apparatus 100 in the embodiment has an iFAX function. Therefore, the image forming apparatus 100 is capable of transmitting and receiving an e-mail in response to an operation of the user using the iFAX function. In addition, in the following description, a process of the image forming apparatus 100 sending an e-mail by the iFAX function is referred to as an iFAX transmission. In addition, in the following description, a process of the image forming apparatus 100 receiving an e-mail by the iFAX function is referred to as an iFAX reception.

In the example illustrated in FIG. 1, the image forming apparatus 100 includes a display 4, a scanner unit 5, a printing unit 6, and a paper feeding unit 12.

The display 4 is an image display device such as a liquid crystal display and an organic electro luminescence (EL) display. The display 4 operates as an output interface, and displays characters and images. For example, the display 4 displays a setting screen and an input screen. The setting screen is a screen on which the user performs the setting of the iFAX. The input screen is a screen on which the user inputs a destination address at the time of using the iFAX. Further, the display 4 operates as an input interface, and receives an instruction input from the user. The instruction that is input on the display 4 is input to the image forming apparatus 100.

The scanner unit 5 is a color scanner including, for example, a contact image sensor (CIS), a charge coupled device (CCD), and the like. The scanner unit 5 reads an image on the sheet using the sensors, and generates digital data.

The printing unit 6 prints images, characters, and the like on the sheet.

The paper feeding unit 12 supplies the printing unit 6 with sheets for printing.

FIG. 2 is a block diagram illustrating a functional configuration of the image forming apparatus 100 in the first embodiment.

The image forming apparatus 100 includes a central processing unit (CPU) 1, a network interface 2, an auxiliary storage device 3, a display 4, a scanner unit 5, a printing unit 6, an image processing unit 7, and a memory 8. The respective functional units included in the image forming apparatus 100 are connected to an internal bus 10, and can perform input and output of data to each other. In addition, the functional units illustrated in FIG. 2 are denoted by the same reference numerals as in FIG. 1, and thus the description thereof will be omitted.

The CPU 1 controls the operation of each functional unit in the image forming apparatus 100. The CPU 1 executes various processes by executing a program. The CPU 1 acquires an instruction that the user inputs, from the display 4. The CPU 1 executes a control process, based on the acquired instruction. For example, if there is an instruction to use the iFAX function from the user, the CPU 1 controls the network interface 2 so as to perform transmission and reception of data by the iFAX.

The network interface 2 performs transmission and reception of data with other apparatuses. The network interface 2 operates as an input interface, and receives data transmitted from other apparatuses. Further, the network interface 2 operates as an output interface, and transmits data to other apparatuses.

The auxiliary storage device 3 is, for example, a hard disk or a solid state drive (SSD), and stores various types of data. The various types of data include, for example, digital data, screen data of the setting screen and the input screen, address information, e-mail addresses that have been set in the image forming apparatus 100, a job, a job log, and the like. The digital data refers to digital data that the scanner unit 5 generates. The address information represents information regarding a user name and an e-mail address of each user that the user registers in an address book.

The image processing unit 7 performs image processing on the digital data that the scanner unit 5 generates.

The memory 8 is, for example, a random access memory (RAM). The memory 8 temporarily stores the data that is used by each functional unit included in the image forming apparatus 100. In addition, the memory 8 may store the digital data that the scanner unit 5 generates. The memory 8 may temporarily store a job and a job log.

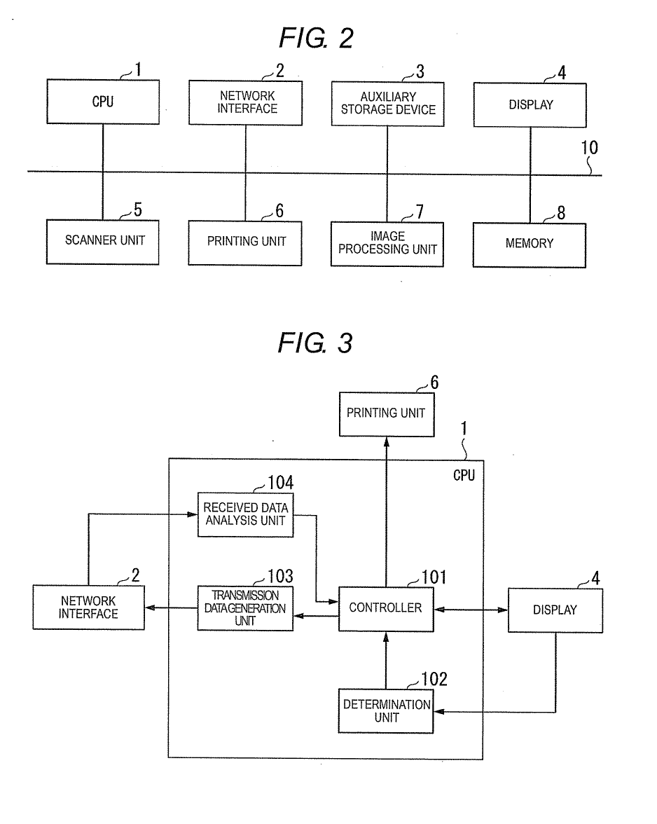

FIG. 3 is a schematic block diagram illustrating a functional configuration of the CPU 1 in the first embodiment.

As illustrated in FIG. 3, the CPU 1 includes a controller 101, a determination unit 102, a transmission data generation unit 103, and a received data analysis unit 104.

The controller 101 controls each functional unit of the CPU 1. For example, the controller 101 performs a control process with respect to a generation instruction of transmission data at the time of using the iFAX, a printing operation by the printing unit 6 in response to a job, and a transfer operation by the network interface 2.

The determination unit 102 performs determination of the settings of the iFAX, based on the instruction input to the display 4.

The transmission data generation unit 103 generates transmission data according to the determination result of the determination unit 102.

The received data analysis unit 104 analyzes data received by the network interface 2 (hereinafter, referred to as “received data”). For example, the received data analysis unit 104 analyzes whether or not the source of the received data is the image forming apparatus 100, based on the information included in the header of the received data.

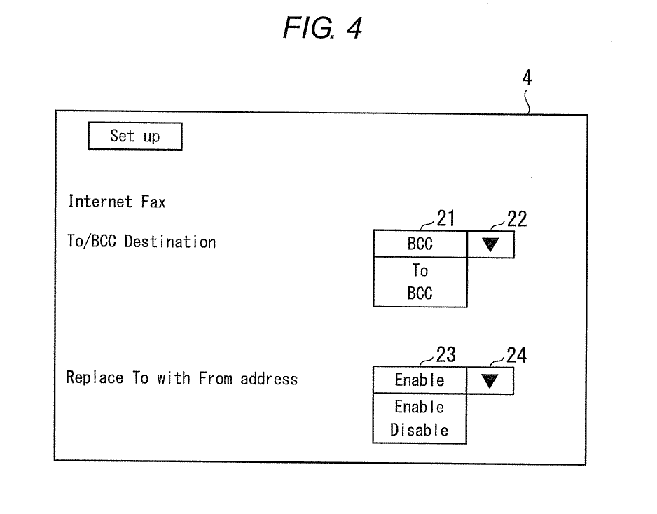

FIG. 4 is a diagram illustrating a specific example of the setting screen.

The setting screen illustrated in FIG. 4 is displayed on the display 4, in response to the operation of the user. For example, when the user operates the display 4 and inputs an instruction to perform the setting of the iFAX, the set ting screen is displayed on the display 4 by the CPU 1.

Two setting items are displayed on the setting screen illustrated in FIG. 4. The two setting items are “To/BCC Destination” and “Replace To with From address”.

The “To/BCC Destination” item is an item for selecting whether to set all of the destination addresses in the To item or the BCC item.

The “Replace To with From address” item is an item for selecting whether or not to set the source address in the To item. Hereinafter, “To/BCC Destination” item and “Replace To with From address” item will be described. In addition, in the following description, “To/BCC Destination” item will be described as a first item. Further, in the following description, “Replace To with From address” item will be described as a second item.

A selection display area 21 and a selection candidate display button 22 are associated in the first item. The selection display area 21 represents an area for displaying the settings selected by the user. The selection candidate display button 22 represents a button for displaying user-selectable settings in the first item. If the selection candidate display button 22 is pressed by the user, the user-selectable settings are pull-down displayed (see the lower end of the selection display area 21). In FIG. 4, there are To and BCC as the user-selectable settings in the first item. The user selects To or BCC by operating the display 4. In other words, the setting of To or BCC is displayed on the selection display area 21.

The selection display area 23 and the selection candidate display button 24 are associated in the second item. The selection display area 23 represents an area for displaying the settings selected by the user. The selection candidate display button 24 represents a button for displaying the user-selectable settings in the second item. If the selection candidate display button 24 is pressed by the user, the user-selectable settings are pull-down displayed (see the lower end of the selection display area 23). In FIG. 4, the re are “Enable” and “Disable” as the user-selectable setting s in the second item. The user selects “Enable” or “Disable” by operating the display 4. In other words, the setting of “Enable” or “Disable” is displayed on the selection display area 23. Here, “Enable” represents inputting the source address (an e-mail address of the image forming apparatus 100) to the To item in the e-mail. “Disable” represents that the source address is not input to the To item in the e-mail.

In addition, the second item is a selectable item when BCC is selected in the first item. In other words, when the user selects To in the first item, the second item cannot be selected. In this case, the CPU 1 performs control so as not to be able to select the second item. For example, the CPU 1 performs control such that the selection display area 23 is grayed out and displayed.

Respective settings that are set on the setting screen are stored in the auxiliary storage device 3. In addition, in the following description, the settings that are set in the first item are described as the destination setting. Further, in the following description, the settings that are set in the second item are described as information setting for the image forming apparatus 100.

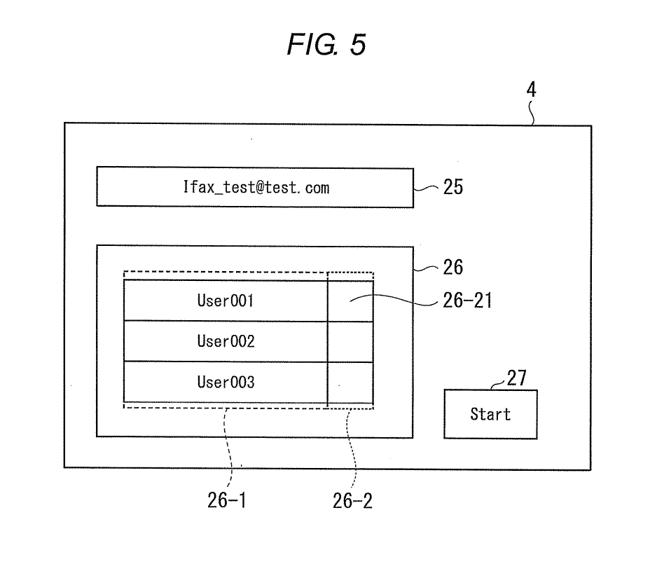

FIG. 5 is a diagram illustrating a specific example of the input screen.

The input screen illustrated in FIG. 5 is displayed on the display 4 by the CPU 1, when the user inputs an instruction to use iFAX by operating the display 4. An address direct input area 25, an address selection area 26, and a Start button 27 are displayed on the input screen illustrated in FIG. 5.

The address direct input area 25 represents an area for the user's direct input of the destination address. If the address direct input area 25 is selected by the user, it is possible to input the destination address.

The address selection area 26 represents an area for the user's selection of the address as a destination among the e-mail addresses registered by the user in advance in the address book. In FIG. 5, an address information display area 26-1 and a selection existence area 26-2 are displayed on the address selection area 26.

The address information display area 26-1 represents an area for displaying the address information stored in the auxiliary storage device 3. In the example illustrated in FIG. 5, three pieces of address information are displayed in the address information display area 26-1. The three pieces of address information are User001, User002, and User003. In addition, when four or more pieces of address information are stored in the auxiliary storage device 3, another piece of address information is displayed by the user scrolling up and down in the address selection area 26.

The selection existence area 26-2 represents an area for indicating whether or not each piece of address information displayed in the address information display area 26-1 is selected by the user. If certain address information is selected by the user from the address information display area 26-1, the CPU 1 displays a predetermined symbol in the selection existence area 26-2 of the selected address information. Specifically, if User001 is selected by the user, the CPU 1 displays a predetermined symbol in the selection existence area 26-21 corresponding to the selected address information User001. The predetermined symbol is a symbol that is visible to the user. For example, the predetermined symbol is a check mark, a circle, and the like. In addition, the predetermined symbol may be any symbol other than the above symbols as long as it is a symbol visible to the user.

The Start button 27 represents a button for causing the image forming apparatus 100 to execute the transmission of data by the iFAX. If the Start button 27 is selected by the user, the image forming apparatus 100 performs the transmission of an e-mail by the iFAX, based on the settings and the set address information.

The user may perform the setting of the destination address in any of the address direct input area 25 and the address selection area 26. For example, the user may perform the setting of the destination address only in the address direct input area 25, or may perform the setting of the destination address only in the address selection area 26. Further, the user may perform the setting of the destination address in both of the address direct input area 25 and the address selection area 26.

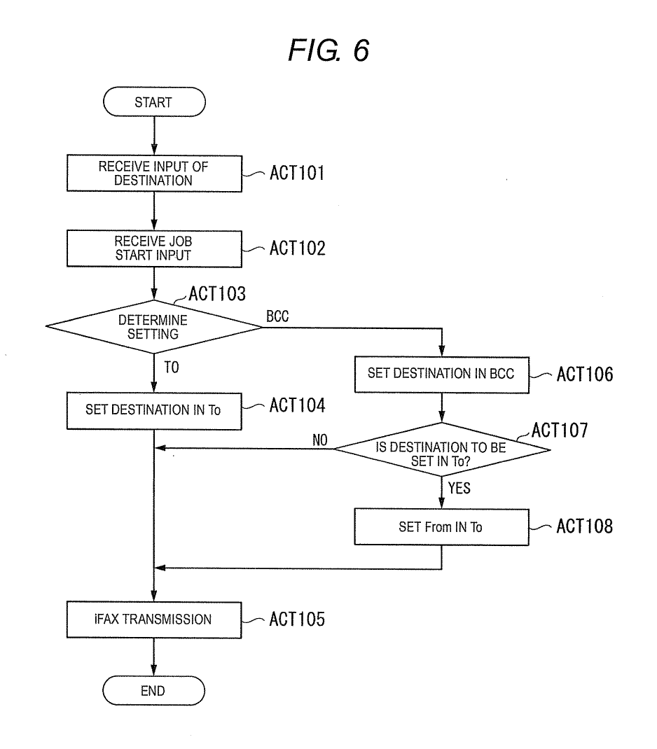

FIG. 6 is a flowchart illustrating the flow of a process at the time of iFAX transmission by the image forming apparatus 100 in the first embodiment. In addition, the case when the settings are already set will be described as an example with reference to FIG. 6.

If an instruction to use the iFAX is input from the user, the controller 101 displays an input screen on the display 4. The display 4 displays an input screen according to the control of the controller 101, and receives an input of the destination address (ACT101). Specifically, the display 4 receives either a direct input from the address direct input area 25 or the selection from the address selection area 26. Further, the display 4 receives an instruction input of a job start from the user (for example, an instruction input by selection of the Start button 27) (ACT102).

If the instruction of the job start is input from the user, the determination unit 102 performs the determination process based on the settings of the iFAX stored in the auxiliary storage device 3. Specifically, the determination unit 102 determines whether the destination setting is To or BCC (ACT103).

When the destination setting is To (ACT103: To), the controller 101 recognizes that all of the input destination addresses are to be set in the To item (ACT104). Thereafter, the scanner unit 5 reads an image on the sheet that is set, and generates digital data. Further, the scanner unit 5 registers the job of iFAX transmission, in the auxiliary storage device 3. The controller 101 outputs the information about setting that is recognized in the process of ACT104, and information about the destination address that is input in the process of ACT101, to the transmission data generation unit 103.

Thereafter, the transmission data generation unit 103 generates transmission data, based on each piece of output information and the digital data stored in the auxiliary storage device 3. At this time, the transmission data generation unit 103 sets all of the e-mail addresses indicated by the information about the destination address to the To item. Then, the transmission data generation unit 103 outputs the generated transmission data to the network interface 2. Thereafter, the network interface 2 performs the iFAX transmission (ACT105).

When the destination setting is BCC (ACT103: BCC), the controller 101 recognizes that all of the input destination addresses are to be set in the BCC item (ACT106). In this case, the determination unit 102 determines whether the e-mail address of the image forming apparatus 100 is to be set in the To item with reference to the auxiliary storage device 3 (ACT107). More specifically, the determination unit 102 determines whether or not the information setting for the image forming apparatus 100 is “Enable”. When the information setting for the image forming apparatus 100 is “Enable”, the determination unit 102 determines that the e-mail address of the image forming apparatus 100 is to be set in the To item. In contrast, when the information setting for the image forming apparatus 100 is not “Enable”, in other words, “Disable”, the determination unit 102 determines that the e-mail address of the image forming apparatus 100 is not to be set in the To item.

When the e-mail address of the image forming apparatus 100 is not to be set in the To item (ACT107: NO), the following process is performed. First, the scanner unit 5 reads an image on the sheet that is set, and generates digital data. Further, the scanner unit 5 registers the job of iFAX transmission to the auxiliary storage device 3. The controller 101 outputs information about the setting that is recognized in the process of ACT106 and information about the destination address that is input in the process of ACT101, to the transmission data generation unit 103.

Then, the transmission data generation unit 103 generates transmission data, based on the each piece of output information and the digital data stored in the auxiliary storage device 3. At this time, the transmission data generation unit 103 sets all of the e-mail addresses indicated by the information about the destination address, in the BCC item. Then, the transmission data generation unit 103 outputs the generated transmission data to the network interface 2. Then, the network interface 2 performs the iFAX transmission (ACT105).

In the process of ACT107, the e-mail address of the image forming apparatus 100 is to be set in the To item (ACT107: YES), and the following process is performed. First, the controller 101 recognizes that the e-mail address of the image forming apparatus 100 is to be set to the To item (ACT108). Next, the scanner unit 5 reads an image on the sheet that is set, and generates digital data. Further, the scanner unit 5 registers the job of iFAX transmission to the auxiliary storage device 3. The controller 101 outputs the information about the destination address, information about the setting that is recognized in the process of ACT104, and information about the setting that is recognized in the process of ACT108, to the transmission data generation unit 103.

Then, the transmission data generation unit 103 generates transmission data, based on each piece of output information and the digital data stored in the auxiliary storage device 3. At this time, the transmission data generation unit 103 sets all of the e-mail addresses indicated by the information about the destination address, to the BCC item, and sets the e-mail address of the image forming apparatus 100 to the To item. Then, the transmission data generation unit 103 outputs the generated transmission data to the network interface 2. Then, the network interface 2 performs iFAX transmission (ACT105).

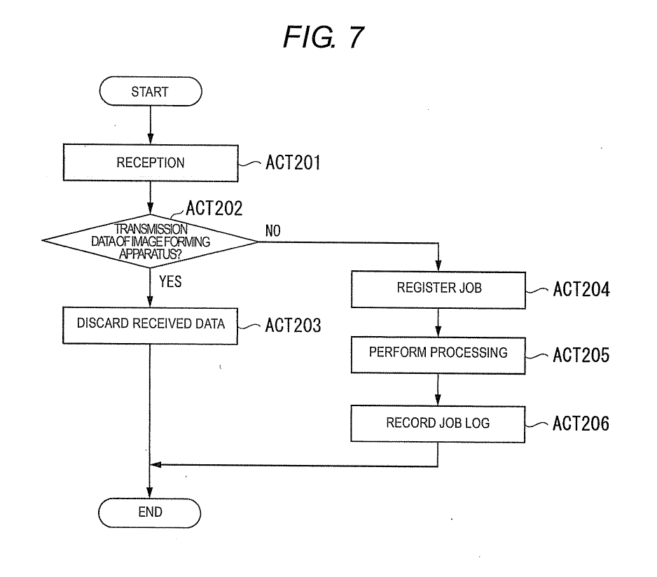

FIG. 7 is a flowchart illustrating a flow of a process at the time of iFAX reception by the image forming apparatus 100.

The network interface 2 receives transmission data (ACT201). The network interface 2 outputs the received data to the received data analysis unit 104. The received data analysis unit 104 determines whether or not the received data is the transmission data of the image forming apparatus 100 by analyzing the received data (ACT202).

Specifically, first, the received data analysis unit 104 acquires the e-mail address that is set in the To item, from the header portion of the received data. Next, the received data analysis unit 104 determines whether or not the acquired e-mail address and the e-mail address that is set in the image forming apparatus 100 match. Then, when the e-mail addresses match, the received data analysis unit 104 determines that the received data is the transmission data of the image forming apparatus 100. Meanwhile, when the e-mail addresses do not match, the received data analysis unit 104 determines that the received data is not the transmission data of the image forming apparatus 100.

When the received data is the transmission data of the image forming apparatus 100 (ACT202: YES), the received data analysis unit 104 does not perform the job registration, and discards the received data (ACT203).

In contrast, when the received data is not the transmission data of the image forming apparatus 100 (ACT202: NO), the received data analysis unit 104 performs the job registration of the iFAX reception to the auxiliary storage device 3 (ACT204). In this case, the controller 101 performs a predetermined process based on the job that is registered to the auxiliary storage device 3 (ACT205). For example, the controller 101 controls the printing unit 6 so as to perform the printing of the received data. Then, the controller 101 records the execution result of a predetermined process in the auxiliary storage device 3 as a job log (ACT206).

The image forming apparatus 100 in the first embodiment that is configured in this manner does not perform job registration and discards data, when receiving data transmitted from the image forming apparatus 100 by iFAX transmission. Accordingly, whenever receiving the data transmitted by iFAX transmission, the image forming apparatus 100 performs control so as not to perform useless printing or transferring. Therefore, it is possible to reduce the possibility of performing useless processes for sending an e-mail to a destination which is set in the BCC item.

Further, a setting screen for setting the settings in the iFAX transmission is displayed on the image forming apparatus 100. The user sets whether to set all of the destination addresses of other apparatuses in the To item or the BCC item, as the destination setting on the setting screen. Further, the user sets whether or not to set the e-mail address of the image forming apparatus 100 in the To item, as the information setting for the image forming apparatus 100 on the setting screen. Only when BCC is set as the destination setting and “Enable” is set as the information setting for the image forming apparatus 100, does the image forming apparatus 100 receive the transmission data transmitted from the image forming apparatus 100. Then, the image forming apparatus 100 discards the transmission data transmitted from the image forming apparatus 100 and does not perform useless processes. Since the e-mail address is set in the To item, it is possible to reduce the possibility of discarding the transmission data as junk e-mail in another apparatus. Therefore, it is possible to reduce processing loads in the image forming apparatus 100, and reliably transmit the transmission data to the destination that is set in the BCC item.

### Second Embodiment

A second embodiment is different from the first embodiment in the header configuration of the transmission data at the time of iFAX transmission and the analysis method of the received data at the time of iFAX reception. In the second embodiment, only the configuration different from in the first embodiment will be described.

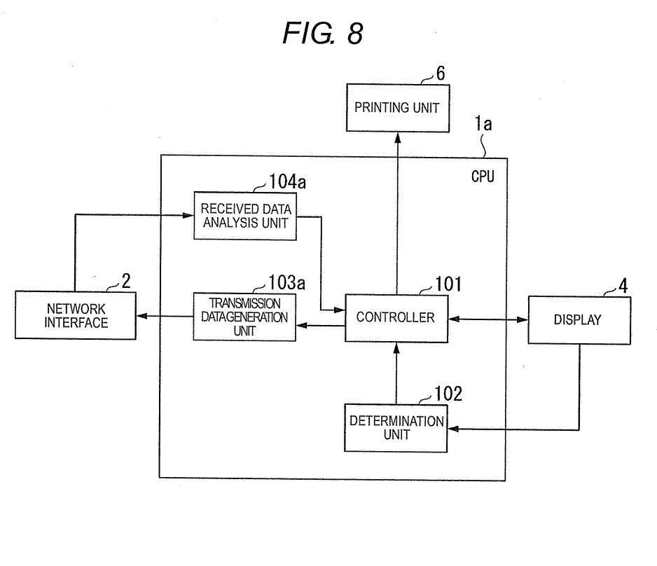

FIG. 8 is a schematic block diagram illustrating a functional configuration of a CPU 1a in the second embodiment.

As illustrated in FIG. 8, the CPU 1a includes a controller 101, a determination unit 102, a transmission data generation unit 103a and a received data analysis unit 104a. In addition, the functional units in the CPU 1a in the second embodiment that perform the same processes as those in the CPU 1 in the first embodiment are denoted by the same reference numerals, and thus the description thereof will be omitted.

The transmission data generation unit 103a generates transmission data according to the determination result of the determination unit 102. For example, when the e-mail address of the image forming apparatus 100 is to be set in the To item, the transmission data generation unit 103a adds specific identification information to the header portion of the transmission data. More specifically, the transmission data generation unit 103a adds the specific identification information to a freely-selectable area according to the iFAX function using a simple mail transfer protocol (SMTP). The specific identification information is information for identifying that the transmission data is transmitted from the image forming apparatus 100. For example, the specific identification information is information that is registered in advance to the image forming apparatus 100 such as a serial number, a MAC address, and the like of the image forming apparatus 100. In addition, the specific identification information is stored in the auxiliary storage device 3.

The received data analysis unit 104a analyzes the received data. For example, the received data analysis unit 104a analyzes whether or not the source of the received data is image forming apparatus 100, based on the information included in the header of the received data.

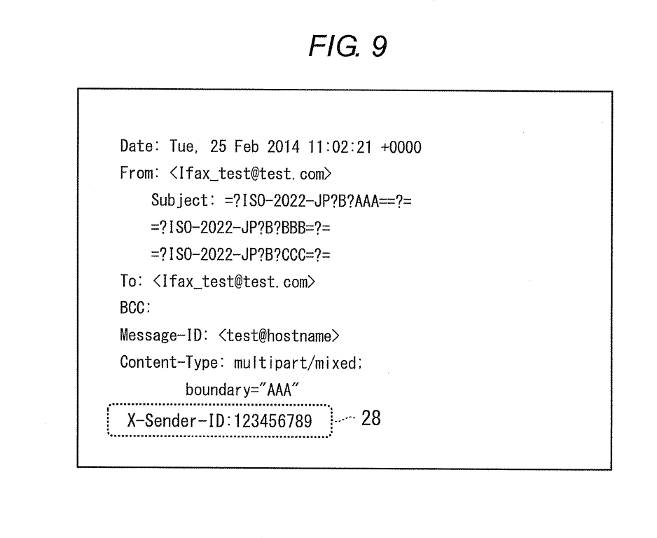

FIG. 9 is a diagram illustrating an example in which specific identification information is added to the header of the transmission data.

In FIG. 9, specific identification information (X-Sender-ID: 123456789) indicated by an area 28 is illustrated in the header portion. In FIG. 9, the specific identification information is added to the bottom of the header portion, but the specific identification information may be added to the display name of the To item or the “From” item.

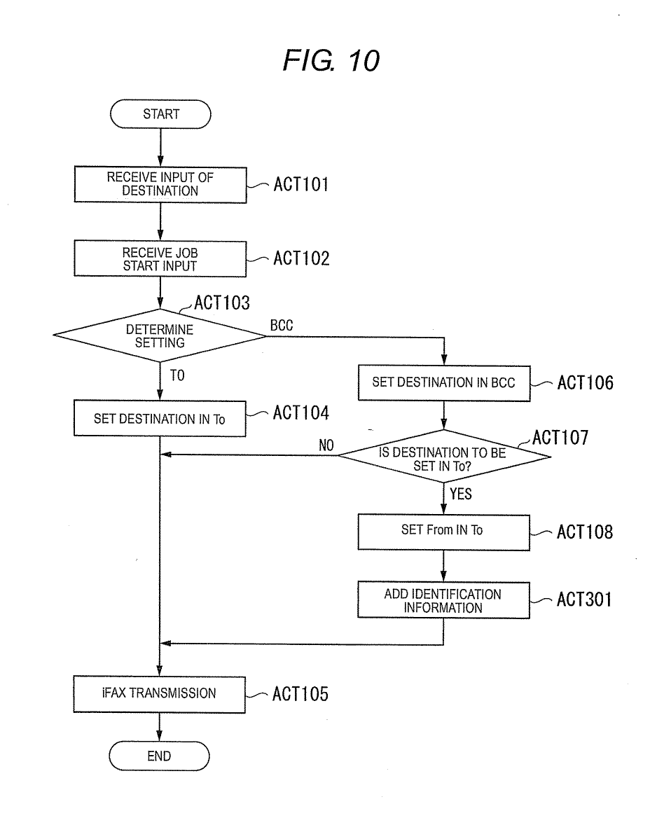

FIG. 10 is a flowchart illustrating a flow of a process at the time of iFAX transmission by the image forming apparatus 100 in the second embodiment. In addition, FIG. 10 illustrates a case when the settings are already set as an example. Further, the same processes in FIG. 10 as in FIG. 6 are denoted by the same reference numerals as in FIG. 6, and thus the description thereof is omitted.

If the process of ACT108 is ended, next, the scanner unit 5 reads an image on the sheet that is set, and generates digital data. Further, the scanner unit 5 registers the job of iFAX transmission to the auxiliary storage device 3. The controller 101 outputs information about the destination address, information about the setting that is recognized in the process of ACT104, and information about the setting that is recognized in the process of ACT108 to the transmission data generation unit 103a.

Then, the transmission data generation unit 103a generates transmission data, based on each piece of output information and the digital data stored in the auxiliary storage device 3. At this time, the transmission data generation unit 103 sets all of the e-mail addresses indicated by the information about the destination address in the BCC item, and sets the e-mail address of the image forming apparatus 100 in the To item. Further, the transmission data generation unit 103a adds the specific identification information to the header portion (ACT301). Then, the transmission data generation unit 103a outputs the generated transmission data to the network interface 2. Then, the process of ACT105 is performed.

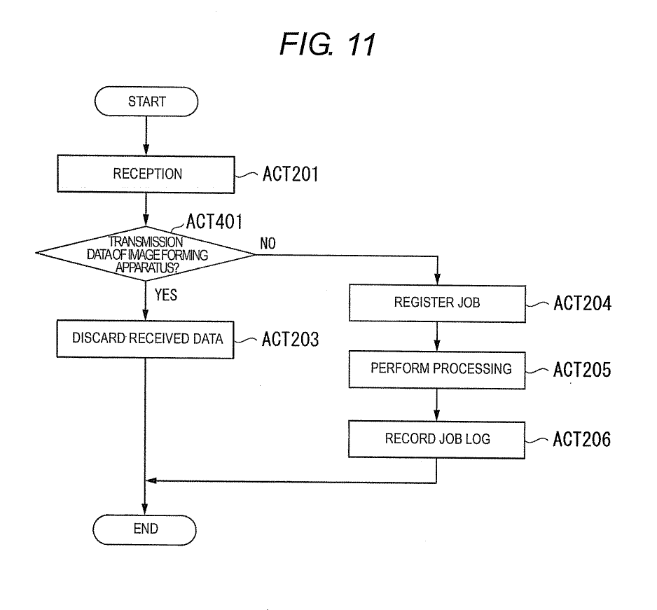

FIG. 11 is a flowchart illustrating a flow of a process at the time of iFAX reception by the image forming apparatus 100 in the second embodiment. In addition, the same processes in FIG. 11 as in FIG. 7 are denoted by the same reference numerals as in FIG. 7, and thus the description thereof is omitted.

If the process of ACT201 is ended, the received data analysis unit 104a determines whether or not the received data is the transmission data of the image forming apparatus 100 by analyzing the received data (ACT401).

Specifically, first, the received data analysis unit 104a determines whether or not the specific identification information is present in the header portion of the received data. When the specific identification information is not present in the header portion of the received data, the received data analysis unit 104a determines that the received data is not the transmission data of the image forming apparatus 100.

In contrast, when the specific identification information is present in the header portion of the received data, the received data analysis unit 104a acquires the specific identification information from the header portion. Next, the received data analysis unit 104a determines whether or not the acquired specific identification information and the specific identification information stored in the auxiliary storage device 3 match. Then, when the two pieces of specific identification information match, the received data analysis unit 104a determines that the received data is the transmission data of the image forming apparatus 100. In contrast, when the two pieces of specific identification information do not match, the received data analysis unit 104a determines that the received data is not the transmission data of the image forming apparatus 100. Then, the processes subsequent to ACT203 or ACT204 are performed.

When the image forming apparatus 100 in the second embodiment that is configured in this manner receives data that is transmitted from the image forming apparatus 100 by the iFAX transmission, the image forming apparatus 100 does not perform job registration and discards data. More specifically, the image forming apparatus 100 adds specific identification information to the transmission data at the time of iFAX transmission, and discards the received data when the specific identification information matches the received data at the time of iFAX reception. In the image forming apparatus 100 in the first embodiment, determination is performed as to whether or not the transmission data is data that is transmitted from the image forming apparatus 100, based on the comparison result of the e-mail addresses. However, in this case, since the source address is replaced with the user's address, the e-mail addresses may not match. In contrast, in the image forming apparatus 100 in the second embodiment, the determination is performed based on the specific identification information which is registered in advance in the image forming apparatus 100. Therefore, it is possible to further reduce the possibility of performing useless processes for sending an e-mail to a destination which is set in advance in the BCC item than in the first embodiment.

Further, a setting screen for setting the settings in the iFAX transmission is displayed on the image forming apparatus 100. The user sets whether to set all of the destination addresses of other apparatuses in the To item or the BCC item, as the destination setting on the setting screen. Further, the user sets whether or not to set the e-mail address of the image forming apparatus 100 in the To item, as the information setting for the image forming apparatus 100 on the setting screen. The image forming apparatus 100 receives the transmission data to which the specific identification information is added, only when BCC is set in the destination setting and the information setting for the image forming apparatus 100 is set to “Enable”. Then, in the image forming apparatus 100, the transmission data that is transmitted from the image forming apparatus 100 is discarded and the process is ended without performing a useless process. In other devices, it is possible to reduce the possibility of discarding the e-mail as junk e-mail, because the e-mail address is set in the To item. Therefore, it is possible to reduce the processing load in the image forming apparatus 100, and to transmit the transmission data to the destination that is set in the BCC item more reliably.

Hereinafter, a modification which is common to each embodiment will be described.

In the above embodiment, there is described a configuration in which the user performs an input on the setting screen and the input screen, through the display 4, but the embodiment does not need to be limited thereto. For example, the user may perform an input on the setting screen and the input screen, through an information processing apparatus, such as a personal computer, which is connected to the image forming apparatus 100.

The process in the present embodiment is applicable to another communication apparatus having an iFAX function.

Further, the embodiment is described by using iFAX as an example, but it is also applicable to a system that sets the destination address only in the BCC item as the e-mail and is capable of transmitting the e-mail.

At least one embodiment described above includes a transmission data generation unit 103 which sets an e-mail address of the other devices in the BCC item in an e-mail, sets the e-mail address of the image forming apparatus 100 in the To item in the e-mail, and generates transmission data, a network interface 2 that transmits the transmission data to the apparatus that is set in the BCC item and the To item, and receives the transmission data, and the received data analysis unit 104 that analyzes the transmission data, and when the transmission data is data transmitted from the image forming apparatus 100, discards the transmission data, and does not perform job registration, and if the transmission data is not the data transmitted from the image forming apparatus 100, performs the job registration, and thus it is possible to reduce the possibility of performing useless processes for sending an e-mail to a destination which is set in the BCC item.

The functions of the above-described image forming apparatus 100 in the embodiment may be realized by a computer. In this case, the functions may be realized by recording a program for implementing the functions in a computer-readable recording medium, reading the program recorded on the recording medium into a computer system, and executing the program. In addition, the “computer system” here is intended to include an OS and hardware such as peripheral devices. The “computer-readable recording medium” means a portable medium such as a flexible disk, a magneto-optical disk, a ROM, and a CD-ROM, or a storage device such as a hard disk built into the computer system. Furthermore, the “computer readable recording medium” is any of those that can dynamically hold a program for a short period of time, such as a communication line when a program is transmitted through a network such as the Internet or a communication line such as a telephone line, and may include any of those that can hold a program for a fixed period of time, such as a volatile memory inside the computer system which is a server or a client. Further, the program may be any of those that can implement a portion of the above functions, or any of those that can implement the aforementioned functions in combination with a program already recorded on the computer system.

While certain embodiments have been described, these embodiments have been presented by way of example only, and are not intended to limit the scope of the inventions. Indeed, the novel embodiments described herein may be embodied in a variety of other forms: furthermore various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A communication apparatus comprising:
a transmission data generation unit that generates transmission data by setting an e-mail address of another apparatus in a BCC item, and setting an e-mail address of the communication apparatus in a To item;
a network interface that transmits the generated transmission data to an apparatus which is set in the BCC item and the To item, and receives transmission data; and
a received data analysis unit that analyzes the received transmission data, and when the transmission data is data which is transmitted from the communication apparatus, the transmission data is discarded and job registration is not performed, and when the transmission data is not data which is transmitted from the communication apparatus, the job registration is performed.

2. The apparatus according to claim 1,
wherein the transmission data generation unit adds specific identification information capable of identifying that a source of the transmission data is the communication apparatus to a header part of the transmission data.

3. The apparatus according to claim 1,
wherein the received data analysis unit determines that the transmission data is data transmitted from the communication apparatus, when an e-mail address of the To item included in a header part of the received transmission data matches the e-mail address that is set in the communication apparatus.

4. The apparatus according to claim 2,
wherein the received data analysis unit determines that the transmission data is data transmitted from the communication apparatus, when specific identification information included in a header part of the received transmission data matches specific identification information that is registered in advance in the communication apparatus.

5. The apparatus according to claim 1, further comprising:
a display that displays a first item for causing the user to select whether to set the e-mail address of another apparatus in the To item or the BCC item in the e-mail, and a second item for causing the user to select whether or not to set the e-mail address of the communication apparatus in the To item,
wherein the transmission data generation unit generates the transmission data when selection is made to set the e-mail address of another apparatus in the BCC item in the first item and set the e-mail address of the communication apparatus in the To item in the second item.

6. A received data analysis method comprising:
generating transmission data by setting an e-mail address of another apparatus in a BCC item in an e-mail, and setting an e-mail address of the communication apparatus in a To item in the e-mail;
analyzing the transmission data received by a network interface that transmits the generated transmission data to an apparatus which is set in the BCC item and the To item and receives transmission data, discarding the transmission data and not performing job registration when the transmission data is data which is transmitted from the communication apparatus, and performing job registration when the transmission data is not data which is transmitted from the communication apparatus.

7. The method according to claim 6,
wherein in the generating transmission data, specific identification information capable of identifying that a source of the transmission data is the communication apparatus is added to a header part of the transmission data.

8. The method according to claim 6,
wherein in the analyzing of the received transmission data, the transmission data is determined as data transmitted from the communication apparatus, when an e-mail address of the To item included in a header part of the received transmission data matches the e-mail address that is set in the communication apparatus.

9. The method according to claim 7,
wherein in the analyzing of the received transmission data, the transmission data is determined as data transmitted from the communication apparatus, when specific identification information included in a header part of the received transmission data matches specific identification information that is registered in advance in the communication apparatus.

10. The method according to claim 6, further comprising:
displaying a first item for causing the user to select whether to set the e-mail address of another apparatus in the To item or the BCC item in the e-mail, and a second item for causing the user to select whether or not to set the e-mail address of the communication apparatus in the To item,
wherein in the generating transmission data, the transmission data is generated when selection is made to set the e-mail address of another apparatus in the BCC item in the first item and set the e-mail address of the communication apparatus in the To item in the second item.
